(19) United States
(12) Patent Application Publication
(10) Pub. No.: US 2022/0047976 A1
(43) Pub. Date: Feb. 17, 2022

(54) Filter Medium for Fluid Filtration, a Method for Manufacturing a Filter Medium and a Fluid Filter

(71) Applicants: Sandler AG, Schwarzenbach/Saale (DE); Mann+Hummel GmbH, Ludwigsburg (DE)

(72) Inventors: Udaya Kumar Rao, Freiberg (DE); Lothar Popp, Muenchberg (DE)

(21) Appl. No.: 17/274,533

(22) PCT Filed: Aug. 13, 2019
(86) PCT No.: PCT/EP2019/071639

§ 371 Date: Mar. 9, 2021

(30) Foreign Application Priority Data
Sep. 10, 2018 (DE) 10 2018 215 358.2

(51) Int. Cl. B01D 39/16

(52) U.S. Cl. CPC B01D 39/1623; B01D 2239/1233; B01D 2239/1216; B01D 2239/0636; B01D 2239/0668; B01D 2239/0622

(57) ABSTRACT

A filter medium for fluid filtration, said filter medium having two layers, including at least one coarse filter layer and a fine filter layer which is arranged downstream of the coarse filter layer in the through-flow direction. The coarse filter layer and the fine filter layer are connected to one another without the use of chemical binding agents. The coarse filter layer and the fine filter layer are each a polymer non-woven of thermoplastic polymer fibres. The fibre fineness of the thermoplastic polymer fibres in the fine filter layer is greater than the fibre fineness of the thermoplastic polymer fibres in the coarse filter layer. The thermoplastic fibres of the coarse filter layer as well as the thermoplastic layers of the fine filter layer are melt-blown fibres.

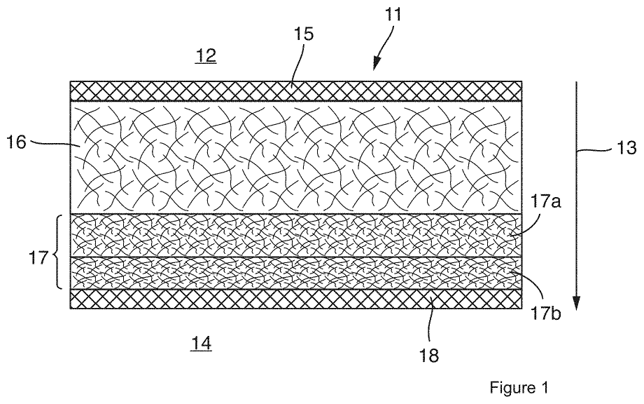

### CROSS-REFERENCE TO RELATED APPLICATIONS

This application is the United States national phase of International Application No. PCT/EP2019/071639 filed Aug. 13, 2019, and claims priority to German Patent Application No. 10 2018 215 358.2 filed Sep. 10, 2018, the disclosures of which are hereby incorporated by reference in their entirety.

### BACKGROUND

### Field

The invention relates to a filter medium for fluid filtration, a method for manufacturing a filter medium and a fluid filter.

### Related Art

It has already been known for some time to apply filter media which consist of non-woven materials for the filtration of liquid and/or gaseous fluids. Due to the variation possibilities and economical manufacture of the non-woven materials, these can be adapted to almost all filtration tasks.

A multi-layered construction of a filter medium which is applied specially for vacuum cleaner bags is known from DE 102 21 694 A1. Here, a coarse layer as a dust storage ply is arranged in front of a fine filter ply of a melt-blown non-woven. A good separation also of fine dust particles is achieved given a sufficient dust storage. However, the thus manufactured construction is not mechanically stable, so that a support layer is necessary at the downstream side, in order to achieve the mechanical strength. The result is a complex, multi-layered construction, wherein the adhesive interconnection of the individual plies by way of adhesive negatively influences the air permeability. If less adhesive is used, then the mechanical stability is again insufficient.

A filter medium for air and liquid filtration is described in DE 20 2007 008 372 U1. The filter medium comprises a coarse filter layer of a thermoplastic staple fibre non-woven material and a fine filter layer of melt-blown fibres, wherein the melt-blown fibres are connected to the staple fibres of the coarse filter layer at defined embossing locations by way of pressure and heat. The plies of the composite are connected to one another in a purely thermal manner by way of pressure and heat without the aid of adhesives.

### SUMMARY

It is the object of the invention to provide a filter medium or a fluid filter which is inexpensively manufacturable in a simple manner and which has separation performances which are at least on par with those filter media or filters which are known from the state of the art. It is further an object to provide a method for manufacturing a filter medium which is more economical compared to conventional manufacturing methods.

This object is achieved by a filter medium with the features of the embodiments described herein, a method for manufacturing a filter medium with the features of the embodiments described herein and a fluid filter with the features of embodiments described herein.

The filter medium according to the invention is characterised in that the thermoplastic polymer fibres of the coarse filter layer as well as the thermoplastic polymer fibres of the fine filter layer are melt-blown fibres.

Both filter layers, thus the coarse filter layer as well as the fine filter layer each consist of a melt-blown non-woven. Such melt-blown non-wovens are manufactured in a simple and inexpensive manner by way of the so-called melt-blow method.

Concerning a melt-blow method, thermoplastic polymers are melted, in particular with the aid of extruders and are subsequently pressed through a multitude of small, very fine nozzles. At the nozzle outlet or directly therebelow, the polymer melt is subjected to hot air which stretches and swirls the exiting filaments in the still fluid state and permits them to be solidified within a few milliseconds. On account of the force of the hot airflow and the fineness of the filaments, these tear quite often, so that very fine filament sections with a greater or lesser length can be deposited on a transport belt directly into a non-woven.

Accordingly, with the filter medium according to the invention, the coarse filter layer and also the fine filter layer are manufactured in a melt-blow method, so that the same manufacturing method can be used for the coarse filter layer as well as for the fine filter layer. Furthermore, it is possible to use melt-blow methods for the manufacture of the coarse filter layer as well as of the fine filter layer, as described above. The melt-blow method is more economical in comparison to other manufacturing method for filter layers of thermoplastic polymer fibres, such as for example the segmented-pie methods. The variation of the fibre fineness between the coarse filter layer and the fine filter layer can be adjusted for example by way of the selection of nozzle openings or flow speed of the hot air. In contrast to the aforementioned state of the art, concerning which the composite consists of a staple fibre non-woven and a melt-blown non-woven which are to be manufactured by way of different manufacturing methods, according to the invention one uses the same types of non-wovens, specifically melt-blown non-wovens, by which means mixed components as in the state of the art are avoided. Such a composite is therefore more economical to manufacture. The filter medium according to the invention is essentially, in particular to 100% synthetic. In comparison to a composite, concerning which one layer comprises glass fibres, this is particularly advantageous with use of such a filter medium in motor vehicle filters, in particular motor vehicle filters in injection systems, since here a glass fibre breakage which damages the filter does not occur.

In a particularly preferred manner, the fibre diameter of the melt-blown fibres in the coarse filter layer lies in the range of 0.8 μm to 5.0 μm, in particular 1.0 μm to 3.0 μm.

Concerning the melt-blown fibres of the fine filter layer, these are preferably nanofibres whose fibre diameter lies in a range of 100 μm to 500 μm, in particular 150 μm to 400 μm.

In a particularly preferred manner, the melt-blown fibres of the coarse filter layer and/or fine filter layer are polyester fibres. The polymer which is used with the melt-blown method is therefore preferably a polyester.

The polyester fibres are preferably polyterephthalate fibres, preferably polyalkylene terephthalate fibres, in particular polyethylene terephthalate (PET) fibres and/or polybutylene terephthalate (PBT) fibres. However, it is also possible to use polypropylene, polyamide, polycarbonate or thermoplastic polyurethane fibres.

The selection of the suitable polymer is directed to the application purpose of the filter medium. In particular, polybutylene terephthalate fibres on account of their high melting point and their high durability are suitable for the filtration of hot and aggressive liquids, e.g. lubrication oil or biodiesel. In contrast, concerning air filtration applications, it tends to be polypropylene or polycarbonate fibres which are applied.

Concerning a further development of the invention, the fibre diameter distribution of the melt-blown fibres in the coarse filter layer and/or fine filter layer is uniform.

Alternatively, it is possible for the fibre diameter distribution of the melt-blown fibres in the coarse filter layer and/or fine filter layer to have a gradient, wherein the fibre diameter in particular continuously reduces in the through-flow direction.

Concerning a further development of the invention, a support layer of non-woven material which is arranged upstream of the coarse filter layer in the through-flow direction and is connected to this without the application of chemical binding agents is present. Expediently, the fibres of the non-woven material of the support layer are thermoplastic polymer fibres, in particular likewise melt-blown fibres, by which means the support layer can likewise be manufactured by the melt-flow method.

In this case, the functionally different layers, the support layer, the coarse filter layer and fine filter layer can be manufactured in a particularly economical manner by the same manufacturing method.

In a particularly preferred manner, the fine filter layer comprises several filter plies of melt-blown, non-woven which are connected to one another without the use of a chemical binding agent, wherein the average of the geometric pore size of the melt-blown non-wovens reduces in the through-flow direction from filter ply to filter ply.

In a particularly preferred manner, the fine filter layer comprises a pre-separation ply of melt-blown non-woven with pores with a pore size of 5 μm to 15 μm, in particular 8 μm to 12 μm.

Particularly preferably, the fine filter layer comprises a main separation ply as a melt-blown non-woven with pores with a pore size of 1 μm to 8 μm, in particular 3 μm to 6 μm.

Concerning a further development of the invention, a protective layer of non-woven material which is arranged downstream of the fine filter layer in the through-flow direction and is connected to this without the use of chemical binding agent is provided. Preferably, the fibres of the non-woven material of the protective layer consist of thermoplastic polymer fibres. It is possible for thermoplastic polymer fibres to be spunbonded, wetlaid and/or carded polymer fibres.

Concerning a further development of the invention, the protective layer comprises a pleating.

The invention further includes a method for manufacturing a filter medium according to one of the embodiments described herein, which comprises the following steps:
arranging the at least one coarse filter layer and the at least one fine filter layer over one another,
bringing energy into the loose composite of coarse filter layer and fine filter layer in a manner such that the melt-blown fibres partly melt and the coarse filter layer and fine filter layer are connected to one another, wherein the connecting of the coarse filter layer and the fine filter layer is effected without the application of chemical binding agents.

It is possible for the melt-blown non-woven of the coarse filter layer to firstly be manufactured by the melt-blow method in a melt-blow facility and the melt-blown non-woven of the fine filter layer to be manufactured independently thereof, in particular at another station of the melt-blow facility. In this manner therefore, melt-blown non-wovens for the coarse filter layer and melt-blown non-wovens for the fine filter layer can be manufactured in parallel, wherein these are then applied over one another in a next step and are connected to one another by way of the introduction of energy and the melting of the fibres. The other function layers, in particular the protective layer can also be manufactured in the melt-blow facility, inasmuch as these are likewise designed as melt-blown non-wovens. For manufacturing the composite which then comprises more than two layers, the different function layers are then again applied over one another and are connected to one another by way of the introduction of energy and melting the melt-blown fibres.

Alternatively, it would however also be possible to provide the composite of the coarse filter layer and the fine filter layer right from the start on manufacturing the melt-blown non-woven of the coarse filter layer and the melt-blown non-woven of the fine filter layer. For this, it would be conceivable to firstly manufacture melt-blown fibres for the coarse filter layer or alternatively melt-blown fibres for the fine filter layer, at a first working station in the melt-blow facility and to deposit them on a transport belt. The deposited non-solidified melt-blown fibres for the melt-blown non-woven of the coarse filter layer or alternatively of the fine filter layer can subsequently be transported to a second working station where melt-blown fibres for the fine filter layer, if the melt-blown fibres of the coarse filter layer have previously been deposited, or melt-blown fibres for the coarse filter layer if melt-blow fibres for the fine filter layer have previously been deposited, are then deposited onto the already deposited melt-blown fibres. In a next step, the solidification and the connection of the loose plies would then be possible by way of the introduction of energy and the melting of the melt-blown fibres.

If the composite should comprise more than two layers, then working stations which are necessary according to the number of layers are to be provided, so that the individual melt-blown fibres of the various layers can be layered over one another. However, it would also be conceivable to manufacture individual function layers separately, for example a protective layer which does not consist of melt-blown fibres and to then deposit this onto the loose composite of the already manufactured fibre layers. It would also be conceivable to manufacture a separately manufactured function layer, for example an onflow-side protective layer in a separate manner and to deposit the melt-blown fibres for the coarse filter layer and the fine filter layer thereon.

Concerning a further development of the invention, the energy introduction is effected by pressing at an increased temperature and increased pressure.

In a particularly preferred manner, the pressing at an increased temperature and increased pressure is effected by way of thermal calendering with the help of a thermo-calender.

It is alternatively possible for the energy introduction to be effected by way of ultrasound, preferably with the help of an ultrasound calender.

The invention further comprises a fluid filter for the filtration of a fluid, for example air or fuel with an onflow opening for raw fluid and with a downstream opening for filtered pure fluid, which is characterised in that at least one filter medium according to one of the embodiments described herein, through which fluid to be filtered can flow in a through-flow direction from the onflow opening to the downstream opening is arranged between the onflow opening and the downstream opening.

Depending on the selection of the melt-blown fibres, the filter medium is suitable for different application purposes, so that it can be applied for example as an air filter, for example in suction systems of motor vehicles or alternatively as a liquid filter, for example as a fuel filter.

### BRIEF DESCRIPTION OF THE DRAWING

A preferred embodiment example of the invention is explained in more detail in the single FIGURE and is hereinafter described in more detail. The FIGURE shows:
a section in the through-flow direction through a preferred embodiment example of the filter medium according to the invention, wherein the filter medium is only shown schematically.

### DETAILED DESCRIPTION

The single FIGURE shows a preferred embodiment example of the filter medium 11 according to the invention. The filter medium 11 which is shown by way of example, in this case consists of five layers or plies. The filter medium can be manufactured in an almost arbitrary manner and can therefore be used as a filter material in a flat surface filter, bag filter, cartridge filter or depth filter for air filtration or as a belt filter, cartridge filter or drum filter for liquid filtration.

A fluid filter with such a filter medium 11 comprises at least one onflow opening (not represented), via which the raw fluid to be filtered enters into the fluid filter. The fluid can be a gaseous medium such as air or other gases to be filtered or alternatively liquids. The raw fluid to be filtered gets to the raw fluid side 12 of the filter medium 11 and flows through this in a through-flow direction 13 and filtered it exits the filter medium 11 at the pure fluid side 14.

Herein, the raw fluid to be filtered successively flows through the different function layers of the filter medium 11.

According to a preferred embodiment example, the raw fluid to be filtered firstly gets into an air-permeable protective layer 15 which is designed as a melt-blown non-woven and which protects the coarse filter layer 16 which lies therein from wear. The filtering effect in the relative thin protective layer is relative low. Expediently, the protective layer in the shown exemplary case consists of melt-blown fibres of polybutylene terephthalate or alternatively polyethylene terephthalate.

After the passage through the protective layer, the still practically unfiltered raw fluid gets into the coarse filter layer which can also be denoted as a particle and/or dust storage layer. Hereby, it is the case of a voluminous melt-blown ply, thus a melt-blown non-woven. In the described embodiment example, polybutylene terephthalate fibres or alternatively polyethylene terephthalate fibres are used as fibres for the melt-blown non-woven. The fibre diameter of the melt-blown fibres in the coarse filter layer in particular lies in the range of 1.0 μm to 3.0 μm. Since the coarse filter layer is a relatively voluminous melt-blown ply, it lends itself for the fibre fineness of the melt-blown fibres to have a gradient within this layer, wherein the fibre fineness becomes greater in the through-flow direction.

After the passage of the pre-filtered raw fluid, said raw fluid being freed of coarse particles which are held back in the coarse filter layer, the raw fluid enters into a fine filter layer 17.

The fine filter layer 17 consist of two plies, of pre-separation ply 17a of a melt-blown non-woven and a main separation ply 17b which is arranged downstream of the pre-separation ply in the through-flow direction 13 and which is likewise of a melt-blown non-woven. Polybutylene terephthalate fibres or alternatively polyethylene terephthalate fibres are applied as melt blown fibres of the pre-separation ply 17a as well as the main separation ply 17b. The fibre structure of the pre-separation ply 17a differs from the fibre structure of the main separation ply 17b. The melt-blown non-woven of the pre-separation ply 17a comprises pores with a pore size of 8 μm to 12 μm. The melt-blown non-woven of the main separation ply 17b in contrast comprises smaller pores, specifically those with a pore size of 3 μm to 6 μm.

The pore sizes can be determined by the so-called bubble-point test. For this, the porous body to be characterised, in this case the pre-separation ply 17a and the main separation ply 17b is completely wetted with a test fluid whose surface tension is low and known. The sample is subsequently subjected to air at one side and the pressure is increased until the first bubble appears. This pressure is denoted as the bubble-point pressure. The apparently largest pore can be computed whilst taking into account the surface tension and the pressure necessary for opening the first pore, amid the assumption of circular pores, according to the following equation:

dₓ=4δ cos φ/Δp

dₓ: apparent pore diameter [m]
δ: surface tension [N/m]
cos φ: wetting angle
Δp pressure difference at the filter [Pa]

The diameter (dₓ) denotes a circularly round pore, whose area is equal to that of the real irregularly shaped pore.

Not only do melt-blown non-woven materials have discrete pore size, but a pore size spectrum. The pore size spectrum can be determined by way of an automated measuring device. For this, the materials are tested in accordance with the technical instruction of the DITF for non-wovens materials “Determining the pore size on the Coulter Porometer. Herein, Coulter Porofil is used as a test fluid. The samples are punched out to a diameter of 25 mm (4.9 cm²) before the measurement. The measurement range extends from 0.07 μm to 300 μm (theoretical pore size)

As already mentioned, the fibre unit of the fine filter layer, thus in the pre-separation ply 17a as well as in the main separation ply 17b is larger than the fibre fineness in the coarse filter layer. The fibre diameter of the melt-blown fibres in the fine filter layer lies in the range of 150 nm to 400 nm.

As is particularly shown in the single FIGURE, a protective layer 18 which in the exemplary case is a spun-bonded non-woven which consists of spun-bonded non-woven fibres is arranged downstream of the fine filter layer 17.

Of course, it is possible for the filter medium to also be constructed of more than five or less than five function layers. What is necessary are a coarse filter layer and a fine filter layer which is arranged downstream in the through-flow direction. For example, it is also possible for the coarse filter layer to comprise several plies which differ from one another with respect to fibre characteristics (fibre diameter, fibre fineness).

The manufacture of the filter medium according to the invention is effected by way of the melt-blow method. A characteristic melt-blow facility (not shown) comprises an extruder, in which plastic granulate is melted. In the exemplary case, polybutylene terephthalate granulate or alternatively polyethylene terephthalate granulate is melted here. The melted granulate is continuously fed to a spinnerette via a spin pump, said spinnerette comprising a melt distributor, a melt filter, various temperature and pressure measurement probes as well as at least one melt-blow nozzle. The polymer melt which is extruded from the nozzle, directly after the exit, is subjected to a converging temperature-regulated airflow of the so-called primary air which mixes with the surrounding air, the so-called secondary air, directly after the nozzle exit. The fibres which form here from the melt cool down on the way to deposition and are captured as intertwined fibres in the form of a non-woven. The depositing is mostly effected on an air-permeable structure such as a deposition belt or a screen drum which is additionally provided with a vacuum. This serves for holding the fibres on the deposit surface and leading away excess primary air.

In the specific exemplary case, it is firstly the fibres for the coarse filter layer which are deposited. Herein, exiting polybutylene terephthalate or alternatively polyethylene terephthalate is deposited in the previously described manner onto a previously manufactured or separately manufactured melt-blown non-woven which forms the protective layer. The loose composite which has arisen here is transported further and is moved to a second working station, at which the melt-blown non-woven of the fine filter layer 17 arises. Herein, it is firstly the polybutylene terephthalate or alternatively polyethylene terephthalate fibres for the pre-separation ply 17a which are applied onto the loose composite of the protective layer and coarse filter layer and subsequently the fibres for the melt-blown non-woven of the main separation ply 17b.

In the subsequent working step, the carrier non-woven of the support layer 18 is then yet deposited onto the loose composite.

The now arisen loose composite of the protective layer 15, coarse filter layer 16, fine filter layer 17 with the pre-separation ply 17a and the main separation ply 17b and the support layer 18 are subsequently connected to one another by way of thermal calendering.

For this, the loose composite is fed to a thermo-calender; herein the loose composite goes through calender rollers, of which at least one is a gravure roller. The distances of the individual connection points are to be selected such that one the one hand they lie sufficiently far apart for the filter-technological characteristics such as fluid permeability and particle storage capacity to remain largely uninfluenced. On the other hand however, the distances of the individual connection points to one another must turn out to be small enough for the downstream melt-blown to be able to expand a little, i.e. the danger of a bursting-open is minimised. For example, it is possible to provide calender gravures with a gravure depth of >1 mm and max. 3 mm. Expediently, the connection surface area (pressing area) does not lie above 25%, in order to ensure the air permeability of the composite. The connection surface area lies in the region of 12% to 18% with respect to the total filter surface.

A comparison of the technical data of a filter medium according to the invention with the known state of the art is given hereinafter.

The product according to the invention herein has the following construction:

### Onflow Side (Coarse Filter Layer):

melt-blown non-woven with a weight of 100 g/m² on polybutylene terephthalate deposited on a PET carrier ply
the PBT melt-blown has an average fibre titre of approx. 1.8 dtex (decitex)
the PET carrier ply is formed from a thermally calender-solidified carded non-woven from a bi-component staple fibre CoPET jacket and with a PET core. This fibre has a titre of approx. 4.4 dtex (decitex) and a staple length of 51 mm. The non-woven has a surface weight of approx. 20 g/m². The solidification area is 100%.

### Downstream Side (Fine Filter Layer):

melt-blown non-woven with a weight of 100 g/m² on polybutylene terephthalate deposited on a PET carrier ply
the PBT melt-blown has an average fibre titre of approx 1.0 dtex
the PET carrier ply is formed by a thermally calender-solidified carded non-woven of a bi-component staple fibre CoPET jacket and with a PET core. This fibre has a titre of approx. 4.4 dtex and a staple length of 51 mm. The non-woven has a surface weight of approx. 20 g/m². The solidification area is 100%.
   Gravure: calender gravure with a pressing surface share of 6% with 6.9 points/cm²

### Comparison Example According to the State of the Art

Onflow side (coarse filter layer): polybutylene terephthalate (PBT) melt-blown ply with a fibre distribution of 1.9 μm to 5.1 μm.
Downstream side (fine filter layer): bi-component ply based on polyamide (PA) on a PET carrier ply with a fibre distribution of 0.45 μm to 2.4 μm

TABLE
comparison of technical data:

| | material according to | | state of the | |
|---|---|---|---|---|
| | the invention | | art | |
| separation efficiency | >99.95% | | >99.95% | |
| (ISO 19438: 2003) | | | | |
| dust retention capacity g/m² | 140 | g/m² | ca. 110 | g/m² |
| (ISO 4020 6.4) | | | | |
| air permeability at 200 Pa | >6 | I/m²/s | 57 | I/m²/s |
| (DIN ISO 9237) | | | | |
| largest pore | 10 | μm | 9 | μm |

It is to be stated that the ply for the downstream side (fine filter layer) from the comparison example from the state of the art is manufactured by way of a so-called segmented-pie process which is more complicated and thus entails greater manufacturing costs in comparison to the described melt-blow method, with which the ply for the downstream side is manufactured.

Despite this, the material according to the invention in regard to the separation efficiency is on par with the state of the art. The dust retention capacity with the material according to the invention is increased compared to the state of the art.

1. A filter medium for fluid filtration, said filter medium comprising two layers, comprising at least one coarse filter layer and a fine filter layer which is arranged downstream of the coarse filter layer in a through-flow direction, wherein the coarse filter layer and the fine filter layer are connected to one another without the use of chemical binding agents, wherein the coarse filter layer and the fine filter layer are each a polymer non-woven of thermoplastic polymer fibres, wherein the fibre fineness of the thermoplastic polymer fibres in the fine filter layer is greater than the fibre fineness of the thermoplastic polymer fibres in the coarse filter layer, and wherein the thermoplastic fibres of the coarse filter layer as well as the thermoplastic layers of the fine filter layer are melt-blown fibres.

2. A filter medium according to claim 1, wherein the fibre diameter of the melt-blown fibres in the coarse filter layer is in the range of 0.8 μm to 5.0 μm.

3. A filter medium according to claim 1, wherein the fibre diameter of the melt-blown fibres in the fine filter layer is in a range of 100 μm to 500 μm.

4. A filter medium according to claim 1, wherein the melt-blown fibres of the coarse filter layer and/or fine filter layer are polyester fibres.

5. A filter medium according to claim 4, wherein the polyester fibres are polyterephthalate fibres.

6. A filter medium according to claim 1, wherein the fibre diameter distribution of the melt-blown fibres in the coarse filter layer and/or fine filter layer is uniform.

7. A filter medium according to claim 1, wherein the fibre diameter distribution of the melt-blown fibres in the coarse filter layer and/or fine filter layer have a gradient, wherein the fibre diameter continuously reduces in the through-flow direction.

8. A filter medium according to claim 1, wherein a protective layer of non-woven material which is arranged upstream of the coarse filter layer in the through-flow direction and is connected to this without the application of chemical binding agents is provided, wherein the fibres of the non-woven material of the protective layer are thermoplastic polymer fibres.

9. A filter medium according to claim 1, wherein the fine filter layer comprises a plurality of filter plies of melt-blown non-woven which are connected to one another without the use of a chemical binding agent, wherein the average of the geometric pore sizes of the melt-blown non-wovens reduces in the through-flow direction from filter ply to filter ply.

10. A filter medium according to claim 9, wherein the fine filter layer comprises a pre-separation ply of melt-blown non-woven with pores with a pore size of 5 μm to 15 μm.

11. A filter medium according to claim 9, wherein the fine filter layer comprises a main separation ply of a melt-blown non-woven with pores with a pore size of 1 μm to 8 μm.

12. A filter medium according to claim 1, wherein a support layer of non-woven material which is arranged downstream of the fine filter layer in the through-flow direction and is connected to this without the use of chemical binding agent is provided, wherein the fibres of the non-woven material of the support layer are thermoplastic polymer fibres.

13. A filter medium according to claim 12, wherein the support layer comprises a pleating.

14. A method for manufacturing a filter medium according to claim 1, comprising the following steps:
arranging the at least one coarse filter layer and the at least one fine filter layer over one another,
bringing energy into the loose composite of coarse filter layer and fine filter layer in a manner such that the melt-blown fibres partly melt and the coarse filter layer and fine filter layer are connected to one another, wherein the connecting of the coarse filter layer and the fine filter layer is effected without the application of chemical binding agents.

15. A method according to claim 14, wherein the energy introduction is effected by pressing at an increased temperature and increased pressure.

16. A method according to claim 15, wherein the pressing at an increased temperature and increased pressure is effected by way of thermal calendering with the help of a thermo-calender.

17. A method according to claim 14, wherein the energy introduction is effected by way of ultrasound with the help of an ultrasound calender.

18. A fluid filter for the filtration of a fluid, comprising an onflow opening for raw fluid and a downstream opening for filtered pure fluid, wherein the at least one filter medium according to claim 1, through which fluid to be filtered can flow in a through-flow direction from the onflow opening to the downstream opening, is arranged between the onflow opening and the downstream opening.
